(19) United States
(12) Patent Application Publication
(10) Pub. No.: US 2025/0308338 A1
(43) Pub. Date: Oct. 2, 2025

(54) Virtual Betting Software

(71) Applicant: Charlie A. Shipp, Austin, TX (US)

(72) Inventor: Charlie A. Shipp, Austin, TX (US)

(21) Appl. No.: 19/091,429

(22) Filed: Mar. 26, 2025

Related U.S. Application Data
(60) Provisional application No. 63/569,817, filed on Mar. 26, 2024.

(51) Int. Cl. G07F 17/32; G06Q 50/34

(52) U.S. Cl. CPC G07F 17/3288; G06Q 50/34

(57) ABSTRACT

In general, in one aspect, embodiments relate to a method, that includes receiving multiple bets from a plurality of users with one or more servers via a network, collectivizing a first group of the multiple bets to form a first group bet, collectivizing a second group of the multiple bets to form a second group bet, executing the first group bet and the second group bet, comparing the first group bet and the second group bet to one or more winning conditions and determining if the first group bet and/or the second group bet is a winning bet based on the one or more winning conditions, and apportioning winnings to the plurality of users associated with the winning bet.

### CROSS-REFERENCE TO RELATED APPLICATION

This is a Non-Provisional application of U.S. Patent Provisional Application No. 63/569,817, filed Mar. 26, 2024, the entire disclosure of which is incorporated herein by reference.

### BACKGROUND

A sportsbook is an on-line forum or a physical establishment that allows gamblers to wager money on predicted outcomes of events (e.g., sporting matchups). Typically, a gambler chooses and registers for a sportsbook, and deposits money. Bets are placed and recorded and, depending on the outcome of the event (or events) gambled on, the sportsbook may disburse winnings (“payout”) to winners.

Gamblers sometimes fall prey to the “the gambler's fallacy”—a belief that the probabilities of future (independent) events are influenced by outcomes of those prior. This unscientific belief can lead individual gamblers, typically acting in isolation, to irresponsibly place bets after a series of losses and incur losses. Traditional sportsbooks encourage isolated betting since bets are placed individually, not collectively.

### BRIEF DESCRIPTION OF THE DRAWINGS

These drawings illustrate certain aspects of some of the embodiments of the present invention and should not be used to limit or define the invention.

FIG. 1 illustrates a workflow for placing bets in a virtual environment, in accordance with some embodiments of the present disclosure.

FIG. 2 illustrates a workflow for a method for placing and receiving bets in a virtual environment, in accordance with some embodiments of the present disclosure.

FIG. 3 illustrates a system showing a network in communication with one or more servers to process bets from multiple gamblers, in accordance with some embodiments of the present disclosure.

FIG. 4 illustrates a workflow for placing bets in a virtual environment using a software application on a mobile device, in accordance with some embodiments of the present disclosure.

FIG. 5 illustrates a login screen of a mobile application, in accordance with some embodiments of the present disclosure.

FIG. 6 illustrates a selection screen of a mobile application, in accordance with some embodiments of the present disclosure.

FIG. 7 illustrates a display screen of a mobile application, in accordance with some embodiments of the present disclosure.

FIG. 8 illustrates a participation screen of a mobile application, in accordance with some embodiments of the present disclosure.

FIG. 9 illustrates a dialogue screen of a mobile application, in accordance with some embodiments of the present disclosure.

FIG. 10 illustrates a result screen of a mobile application, in accordance with some embodiments of the present disclosure.

### DETAILED DESCRIPTION

Disclosed herein are systems and methods for placing bets in a virtual environment. More specifically, disclosed herein is a software for collective betting using a mobile application downloaded on a mobile device.

A “parlay bet” combines multiple individual bets into a single bet. This may offer potentially higher payouts than placing each bet individually. To receive a maximum payout, all bets of a parlay must win. In some examples, if any one of the multiple bets of a parlay loses, the entire parlay bet may be lost.

A “straight line bet” or “straight bet” or “single bet,” is a single bet placed on the predicted outcome of a single event.

A “moneyline bet” is a bet in which a bettor predicts if a team or player will win a game outright, without any point spread.

A “point spread bet,” or “spread,” is a type of betting in which a margin of victory for a favored team is set. Bettors may wager on if the favored team will win by more points than the spread or if the underdog will lose by fewer points than the spread, for example.

An “over/under bet,” or “totals bet,” is a bet where the bettor predicts whether a total combined score of two or more teams in a game will be over or under a specified number. The specified number is referred to as “the total” or “the game total.”

A “proposition bet,” or a “prop bet” or “side bet,” is a type of bet that does not relate directly to the final outcome of a game. Rather, these types of bets are based on specific events or occurrences within a game, match, or event. Non-limiting examples to illustrate include, for example, an individual player performance, occurrence of overtime, occurrence of a homerun, etc.

A “teaser bet” is a type of bet that is similar to a parlay bet in that a bettor combines multiple bets into a single bet, except that the bettor “teases” a point spread or total in their favor. “Teasing” in this context means adjusting a point spread or a total. In some examples, if any one of the multiple bets of a teaser bet loses, the entire teaser bet may be lost.

As mentioned, the gambling industry may allow gamblers to place virtual bets, using on-line sportsbooks. The functionality of on-line sportsbooks is limited to individual betting. An individual gambler places and records bets on the on-line sportsbooks and receives a payout in the event his prediction(s) is/are accurate. Winnings may be higher for bets with lower odds, and lower for bets with higher odds.

In some examples, the systems and methods disclosed herein may allow for collective betting. One advantage of team-based, collective betting, rather than isolated, individual betting, is that individual gamblers of a group may keep each other honest and accountable. In examples, collective betting may provide a more positive social betting atmosphere that dissuades a more compulsive gambler from placing irresponsible bets. Specifically, collective betting may be subject to judgmental scrutiny of a group.

In some examples, the systems and methods disclosed herein may further allow for democratized collective betting. In democratized betting, the risk incurred by any individual gambler is constrained by that which the group as a whole is willing to assume. This may prevent an irresponsible gambler from incurring unnecessary losses (by disallowing him from placing overly risky bets) while still fostering a competitive atmosphere.

In some examples, the virtual betting environment may combine collective betting and/or democratized betting with one or more bet-types selected from: moneyline bets, point spread bets, over/under bets, proposition bets, parlay bets, teaser bets, and any combinations thereof.

While the present disclosure focused mainly on collective betting in a virtual environment, the principles and teachings herein may be applied to non-virtual environments (e.g., traditional sportsbooks) without departing from the scope and spirit of the disclosure. For example, democratized betting using one or more of the bet-types listed above may be performed at a physical establishment, in-person, without using remotely downloaded software, for example.

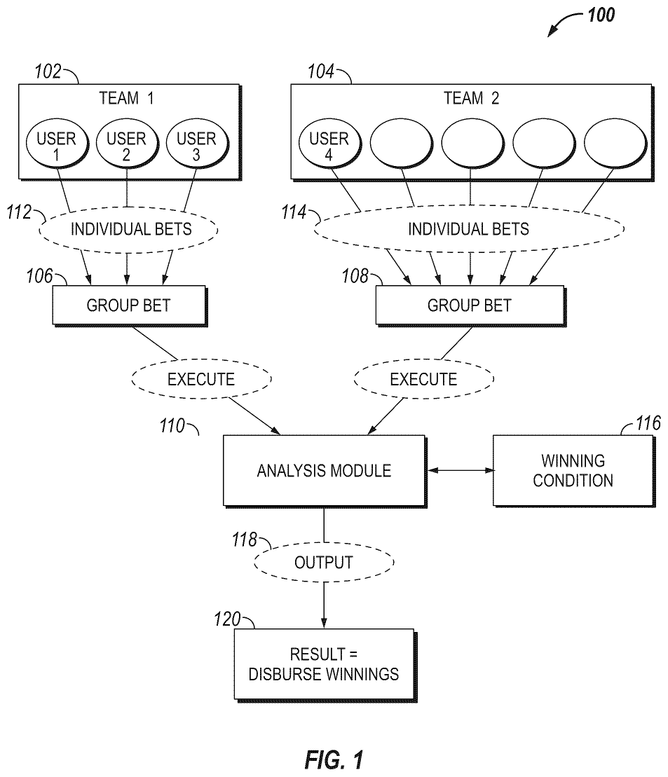

FIG. 1 illustrates a workflow 100 for placing bets 112 in a virtual environment, in accordance with some embodiments of the present disclosure. A workflow 100 for placing bets in a virtual environment may begin with individual users 1, 2, 3, 4, etc. each interacting with a betting interface, e.g., on a mobile device. Devices may be capable of accessing, retrieving data from, or otherwise communicating with, an off-site data management system, such as via a network. This Figure shows how the devices may be utilized by various groups, or teams 102, 104, of users 1, 2, 3, 4, etc. Workflow 100 may be configured to allow any number of teams 102, 104 to participate in a given gambling event at any one time. For example, while this Figure only shows two groups 102, 104, there may be any suitable number, e.g., five, ten, fifty, one hundred, one thousand, etc., and any ranges therebetween.

Group bet 106 represents an outcome of a collective betting process (“polling”) for each user 1, 2, 3 of a team 102. As each user 1, 2, 3 may make different predictions and/or wager different quantities on their predictions, in some examples, there may exist a variety among the different individual bets 112 placed by users 1, 2, 3 or a team 102. This variety may be captured and stored in a dataset (e.g., group bet 106) and maintained at an off-site storage location (e.g., an off-site data management system or server 310 of FIG. 3). Additionally, or alternatively, the individual bets 112 may be separately captured and stored, for later reference. In some examples, since apportionment of winnings (for group bet 106 having met a winning condition 116) among users 1, 2, 3 of a team 102 may depend on these differences, output 118 of analysis module 110 may fractionate winnings among users 1, 2, 3, accordingly. For example, even in democratized collective betting examples, a first user 1 of a team may wager more or less than another user 2 or 3 even if a group bet 106 is the same for users 1, 2, 3 due in some examples to a democratic process, which may involve “voting”. In other examples, however, a quantity wagered by an individual user 1 may also be democratic and/or subject to the outcome of polling (e.g., provided that the amount wagered is within the available funds credited to an account or allocated by user 1 as available for a gambling event, etc.) during formation of group bet 106.

Each team 102, 104 may be populated with an odd (or even) number of users 1, 2, 3, 4, etc. A given team 102 may comprise, in some examples, a team leader or administrator. An administrator may, for example, add or accept invitees to a team 102, schedule a poll, execute a group bet 106, schedule execution of a group bet 106, change a setting of a group event, choose a game-type, make binding decisions for a team 102, create an event involving one or more gambling events, set a minimum (or maximum) buy-in amount, remove users from a team 102, break tied decisions, or the like. One or more of these may be performed by individual users 1, 2, or 3. For example, user 1 may have the ability to opt into a first game-type or gambling event while opting out of another or may add or accept invitees to team 102.

During use, user 1 may place a bet 112, e.g., using a web application or a software downloaded on a mobile device. Bet 112 may comprise one or more wagers associated with one or more predicted outcomes of events. Bet 112 may be a combination of wagers directed to a set of events. Likewise, users 2 and 3 may place bets. These may be processed together, or individually, to form a single group bet 106, or group position, for a given team 102, 104. Thus, each team 102, 104, etc. may have its own, unique group positions (i.e., group bets 106, 108, etc.). As will be discussed in greater detail, a group bet 106 may represent the collective betting of all users 1, 2, 3, etc. within team 102, or a substantial fraction (e.g., majority) thereof, and may be the result of a democratic reduction to a single value or array. Individual bets 112 may be “collectivized” into group bets 106, 108. Group bets 106, 108 may be executed, as illustrated, and input into analysis module 110 (prior to or after collectivization). Analysis module 110 may perform calculations, such as by comparing the data contained with group bet 106 to one or more winning condition(s) 116.

In some examples, users 1, 2, 3 may have the ability to alter a respective individual bet 112 after initial placement, for example, prior to a final execution of group bet 106 to analysis module 110. Thus, group bet 106 may be a “running poll” in some examples, modifiable until scheduled execution of group bet 106, e.g., at a prespecified time, prior to commencement of a match-up, prior to half-time, etc. Execution of multiple group bets 106, 108 for various teams 102, 104 may be scheduled to occur simultaneously or approximately simultaneously. This may ensure that a gambling event remains fair for users 1, 2, 3, 4, etc. of different teams 102, 104 as real-world conditions change (e.g., player injury, weather, change in event venue, etc.) which might alter the real or projected odds of a particular outcome.

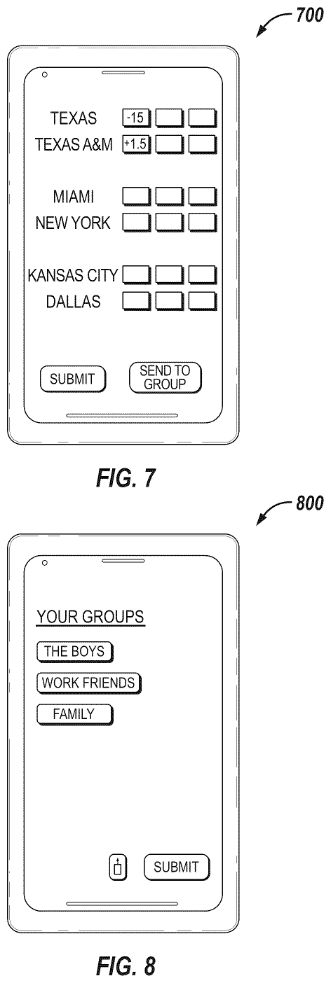

In examples, individual users 1, 2, 3 of a team 102 may access in real-time individual bets 112 placed by other members of team 102, e.g., prior to, during, and/or after execution of group bet 106. As discussed, this may reassure timid gamblers or give pause to risky bettors, in some examples. In addition, real-time global statistics (e.g., median, average, mode, range, standard deviation, etc., of all individual bets 112 placed by users 1, 2, 3, 4, etc. of all teams 102, 104, etc. participating in a gambling event), and/or betting odds (e.g., sportsbooks odds determined from oddsmakers, bookies, artificially intelligent algorithms, etc. as shown in FIG. 7) may be displayed to users 1, 2, 3, 4, etc., e.g., prior to, during, and/or after execution of group bet 106.

Workflow 100 may function to execute individual bets 112 for each user 1, 2, 3, 4, etc. individually or collectively. For example, individual bets 112 may proceed directly to analysis module 110, or may be executed collectively as group bets 106, 108 for each team 102, 104. In cases where individual bets 112 are executed individually, collective betting and/or democratic algorithms may be applied retroactively to the predicted outcomes placed by users 1, 2, 3 of a team 102.

Analysis module 110 may compare the executed group bets to one or more winning conditions 116. Comparison may be a simple binary “pass/fail” of one or more particular predicted outcomes of a group bet 106, e.g., “win/loss,” or may be more complex. For example, for some types of betting events, e.g., point spread bets, analysis module 110 may base its output 118 on a margin of error or accuracy of a predicted final score, point spread, or the like, etc. In calculating winnings, accurate predictions that were unpopular or against the odds may be weighted higher than accurate predictions that were popular or favored by the odds.

Analysis module 110 may employ any suitable formula, algorithm, computation, or process to redistribute winnings to teams with the most accurate predictions. Computations may be performed at an off-site location, such as on a server (e.g., server 310 of FIG. 3). A final output 118 of analysis module 110 may thus trigger a result 120, which may be, for example, actual disbursement of winnings to a bank account, redeemable credit to the account of individual users 1, 2, 3, 4, etc., or the like. A result 120 corresponding to a given user 1 or team 102 may be, in some examples, displayed to the user 1, e.g., on a mobile device (e.g., as shown in FIG. 10), as well as to all users 1, 2, 3 of a team 102, for example.

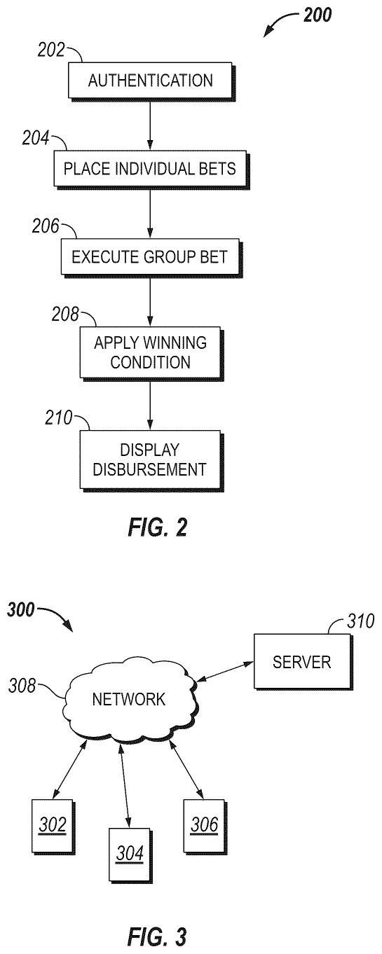

FIG. 2 illustrates a workflow 200 for an example method of placing and receiving bets in a virtual environment, in accordance with some embodiments of the present disclosure. As illustrated, workflow 200 may begin in block 202, where a user 1 (e.g., referring to FIG. 1) may be authenticated. This may involve, for example, verifying a location, identifying a user (e.g., using facial recognition, passcode, password, fingerprint scan, or the like), checking the availability of funds, verifying an age (e.g., at least 18 years old) or adulthood, or otherwise assessing the eligibility of a user 1 to participate in a gambling event. Location data may preclude some users from participation and the ability to place bets may be restricted based on the location data. A credit score below a threshold amount, criminal history, prior abuse, or other failure to satisfy an eligibility criteria may also preclude participation. Block 202 may also involve funding a user account. Funding may involve, for example, connecting a user account to a bank account, withdrawing money, buying sportsbook credit, or the like.

In block 204, user 1 may place a bet 112 (e.g., referring to FIG. 1) using an interface, for example. An interface may be a graphical user interface, display screen, overlay, dashboard, software application rendering, mobile device application window, physical device, written instrument, or the like. As discussed, other information may be displayed to user 1 on an interface, such as local team statistics or data (e.g., parallel bets, participation status, dialogue) as well as global statistics or data, for example.

Data corresponding to bet 112 (e.g., referring to FIG. 1) may be transmitted across a network to a server or data management system, for example, where data associated with user 1, bet 112, group bet 106 may be stored, maintained, processed, and/or retrieved. Similarly, global, user-specific, game-specific, and/or other data may be downloaded to a user device in a similar manner. Notifications may be sent between users 1, 2, 3 of a team 112 based on user activity, such as when bets 112 are placed, invitees are accepted, gambling events are created or offered, group bets 106 are executed, results of past bets become available, winnings are credited or disbursed, games are opted into or out of by users, votes are cast, or the like.

In block 204, placement of bet 112 may deplete the amount of funding in a user account or may trigger withdrawal or charging to a bank account, for example. Such placement of bets may be contingent, for example, on eligibility criteria verified in block 202, which may include sufficiency of funds. In some examples, placement of a bet 112 may be declined if, for example, a user 1 is involved in an unfair or contradictory bet (e.g., on another team), if an amount gambled is too high (e.g., greater than a threshold amount), e.g., for first-time or newer users (such as within 1 or 2 years of account creation), if a user has insufficient track record fairly and honestly using a software or sportsbook, if a user account is suspicious or fraudulent, if a user or a user device is associated with previous policy violations, or the like.

In block 204, a group bet 106 (e.g., referring to FIG. 1) may be executed. As discussed, this may be set to occur at any suitable time or in any suitable fashion, such as when a poll expires, when a scheduled event occurs, begins, or concludes, when decided by a majority of users of a team 102 (e.g., referring to FIG. 1) or by an administrator, as dictated by sportsbook rules, or the like.

In block 208, after a gambling event has concluded, a winning condition 208 is determined and applied to the group bets 106, 108 (e.g., referring to FIG. 1) (e.g., using analysis module 110). Based on the comparison, winnings are apportioned between users and disbursed or credited to individual users in block 210.

FIG. 3 illustrates a system 300 showing a network 308 in communication with a server 310 to process bets from multiple gamblers, e.g., users 1, 2, 3, 4, etc. of FIG. 1, in accordance with some embodiments of the present disclosure. As shown, system 300 may comprise a network 308 in communication with a server 310.

Server 310, which may comprise multiple servers, may provide services, resources, and/or functionality to other computers, software, programs, applications, or the like. Server 310 may be indirectly connected to devices 302, 304, 306 via network 308 (and a router, for example). The connection between server 310 and the devices may allow, for example, a user 1 (e.g., referring to FIG. 1) to download software, execute one or more actions associated with method 200 (e.g., referring to FIG. 2), participate in the placement of one or more bets (e.g., individual bet 112 and/or group bet 106 of FIG. 1), place a bet, execute a bet, view or retrieve local and/or global data, e.g., associated with a team (e.g., team 102 and/or 104 of FIG. 1), purchase and redeem in-app credit, receive winnings, cash out disbursements, link to other software (e.g., payment services, bank applications, etc.), and generally perform any action(s) associated with on-line betting, as discussed herein. Server 310 may comprise physical hardware, which may be entirely or partially virtualized (e.g., virtual private server (VPS) or cloud server), and may be substituted with, or used in combination with, any suitable type of data management system. Server 310 may comprise memory, RAM, CPU(s), or the like. Server 310 may be, for example, a central server separately in communication with one or more client servers, and may handle requests, provide responses to client servers, etc.

Devices 302, 304, 306 may comprise any suitable device and may be capable of displaying a graphical user interface. Non-limiting examples of a device include: a mobile device; tablet; handheld device; computer; laptop; watch; workstation; gaming console; smartphone; media streaming device; home assistant; wearable device; car infotainment system; smart home device; portable media player; appliance; or other suitable device. A device 302 may have the ability to connect to the internet, download and run software, and the like.

Network 308 may comprise, for example, computers, servers, mainframes, network devices, other devices, or combinations thereof, which may connect to one another for the purpose of sharing resources and/or information. Connection(s) may be physical (e.g., cables and wires) or wireless (e.g., using radio waves or infrared signals). In some examples, network 308 may comprise, or else be connected to the internet. Network 308 may allow information of devices operated by individual users 1, 2, 3, 4, etc. (e.g., referring to FIG. 1) to be shared, collected, stored, backed up, remotely accessed, secured, or the like, from a central location (e.g., server 310). Non-limiting examples of types of networks include local area networks, wide area networks, metropolitan area networks, campus area networks, personal area networks, storage area networks, virtual private networks, wireless local area networks, cable networks, cellular networks, satellite networks, mesh networks, client-server networks, peer-to-peer networks, home area networks, industrial control systems, backbone networks, intranet, extranet, sensor networks, cloud networks, and combinations thereof. Network 308 may be a small-scale personal network or a large-scale global network.

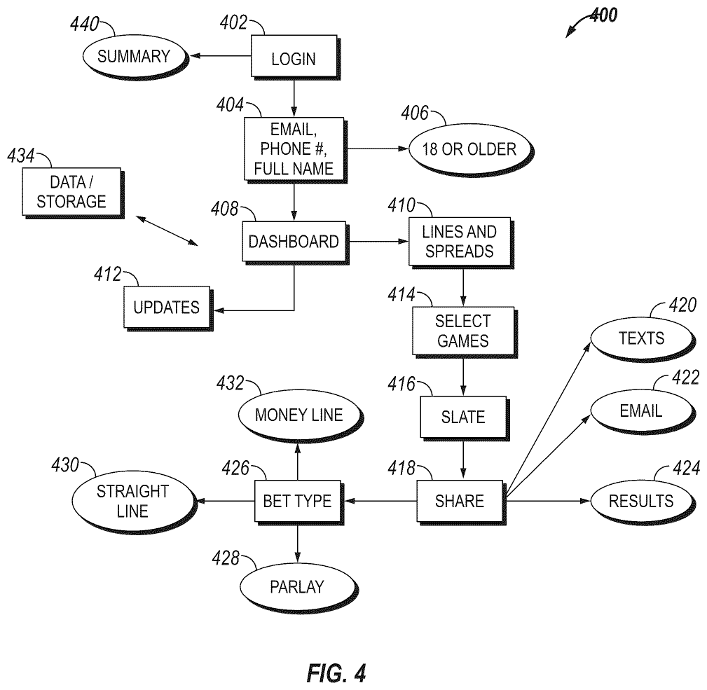

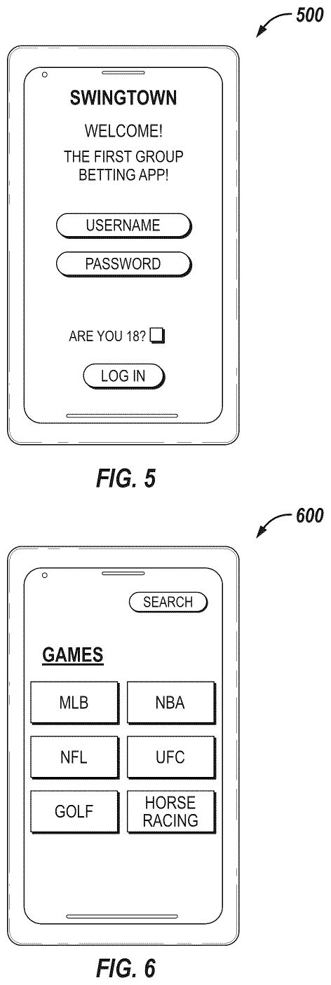

FIG. 4 illustrates a workflow 400 for placing bets in a virtual environment, in accordance with some embodiments of the present disclosure. As illustrated, workflow 400 may comprise a login 402. Upon logging in with login 402 (e.g., using a login screen of FIG. 5), a user 1 (e.g., referring to FIG. 1) may be presented with summary 404, which may comprise general information (e.g., preview, reviews, details, etc.) about functionality of a software, for example. A user 1 may be prompted to input identifying information 404, such as account information (e.g., email, phone number, full name, etc.) which may be used to identify and/or authenticate user 1. User 1 may also be prompted to verify a legal status 406 to ensure that user 1 is legally allowed to participate in one or more activities (e.g., games 428, 430, 432) of workflow 400. User 1 may be presented with a dashboard 408 which may provide various access links or portals to engage with other features, usages, or functions of workflow 400 or a software associated with workflow 400, for example.

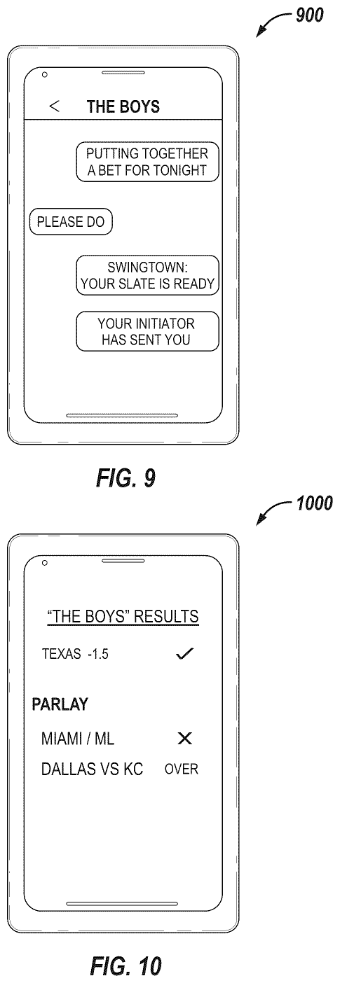

Dashboard 408 may display information about, for example, an upcoming event, a type of game or bet type 426, updates 412, dialogue windows (e.g., tests 420, email 422, and/or dialogue screen 900 of FIG. 9), results 424 of past games, bets or events participated in by user 1 or by other users in a team or worldwide, administrator functions (previously discussed). Dashboard 408 may also display interactive buttons or options to create new gambling events, to invite participants to existing events, to edit or propose edits to existing events, to modify a bet, execute a bet, change a bet-type 426, access a bank account, fund an account, purchase or redeem credit, share an application or a result 424 with a friend, view a status of an outstanding or on-going individual bet or group bet, view odds associated with one or more predictions, generate and/or share odds given an input prediction (e.g., based on odds retrieved from server 310 or network 308 of FIG. 3), combinations thereof, or the like.

User 1 may proceed to lines and spreads 410 which may render, for example, tabulated data (e.g., rows and columns) associated with one or more individual bets 112 and/or group bets 106 (e.g., referring to FIG. 1), which may be past, current, future, or a combination thereof. Such data may correspond to one or more bet types 426 (e.g., parlay 428, straight line 430, money line 432, to use non-limiting examples) and/or games 414 and may represent the data alongside or with network retrievable odds (e.g., retrieved via network 308 of FIG. 3) and/or calculated or generated odds (e.g., using a built-in algorithm, artificial intelligence, pre-trained machine learning model using training data, etc.).

Games 414 may comprise, for example, a specific sports match-up (e.g., basketball, baseball, football, soccer, golf, etc.) and/or a specific tournament (e.g., march madness, golf tournament, etc.) or event, series of events, plurality thereof, and/or combination(s) thereof, or the like. Games 414 may be past, on-going, future, or any combination thereof. Games 414 may be subdivided based on a broader category (e.g., type of sport, calendar date range, local and/or global popularity, bet-type(s), quantity wagered, etc.). User 1 may proceed to slate 416 where data for a selected game 414 may be represented, which may show bets already placed, options to place one or more bets, current status of a group bet, participation in a group bet by other users of a team, or the like. Such data may be represented alongside odds (e.g., probabilities, points, underdog/favorite, etc.).

Workflow 400 may comprise a share option 418. Share option 418 may allow user 1 to invite other users of a team and/or non-users to participate in games 414 and/or bet type(s) 426. An invitation may be sent within a software, directly, or shared via text messaging 420, email 422, social media, or the like. Share option 418 may also allow user 1 to share results 424 of one or more past games or bets.

Results 424 may be results of an individual bet 112 and/or group bet 106 (e.g., referring to FIG. 1). Various bet types 426 may be displayed. User 1 may have the option to select and play various bet types 426, including parlay bets 428, straight line bets 430, and moneyline bets 432. Other examples include, without limitation, point spread bets, over/under bets, proposition bets, and teaser bets. A game may involve one or more of these various bet types 426.

It should be understood that while a particular order of operations is shown in workflow 400 of FIG. 4, these are illustrative in nature and may be rearranged, omitted, and modified, without departing from the scope and spirit of the disclosure.

FIG. 5 illustrates a login screen 500 of a mobile application, in accordance with some embodiments of the present disclosure. Login screen 500 may correspond, for example, to login 402 of FIG. 4. This Figure shows how an option to affirm a legal status 406 (e.g., referring to FIG. 4) may be incorporated into login screen 500. A username and password may also be input using login screen 500.

FIG. 6 illustrates a selection screen 600 of a mobile application, in accordance with some embodiments of the present disclosure. As illustrated, selection screen 600 may display rows and columns pertaining to a plurality of games 414 (e.g., referring to FIG. 4). Selection screen 600 may also have a search function, as illustrated, to browse a large catalogue of sports, games, leagues, events, matches, races, tournaments, sports networks, sports channels, or the like.

FIG. 7 illustrates a display screen 700 of a mobile application, in accordance with some embodiments of the present disclosure. As illustrated, display screen 700 may enable a user 1 (e.g., referring to FIG. 1) to view various games, matches, events, etc., as well as associated odds, in some examples. These may be selected and submitted and/or sent to a group (e.g., team 102 of FIG. 1). Moreover, wagers may be placed on the events selected, e.g., before, after, or without acceptance by a group.

FIG. 8 illustrates a participation screen 800 of a mobile application, in accordance with some embodiments of the present disclosure. Participation screen 800 may display to user 1 (e.g., referring to FIG. 1) the various groups or teams (e.g., team 102 of FIG. 1) user 1 is subscribed to. Participation screen 800 may also have a feature (e.g., link or button) allowing user 1 to create a new team and/or invite others to an existing team or a new team. Moreover, a bet created (e.g., in display screen 700 of FIG. 7 or slate 416 of FIG. 4 or bet 112 of FIG. 1 or block 204 of FIG. 2) by a user 1 may be submitted to multiple teams selected on participation screen 800, for example.

FIG. 9 illustrates a dialogue screen 900 of a mobile application, in accordance with some embodiments of the present disclosure. As shown, a user (e.g., user 1 of FIG. 1) may form dialogue with other users (e.g., users 2, 3) of a group (e.g., team 102), or with friends, followers, invitees, etc., or other users of a software application. In addition, dialogue may be generated by a software, e.g., to notify a group or group member of, for example, an executed bet, a result (e.g., result 120 or 424 of FIGS. 1, 4), group activity, disbursement, winnings, failure or success of satisfying a winning condition (e.g., winning condition 116 of FIG. 1), or the like.

FIG. 10 illustrates a result screen 1000 of a mobile application, in accordance with some embodiments of the present disclosure. Results (e.g., result 120 or 424 of FIGS. 1, 4) may be displayed on result screen 1000. As shown, wins may be shown, for example, with positive signals (e.g., check marks) while losses are shown, for example, with negative symbols (e.g., “X”).

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure. It is also to be understood that the terminology used herein is for the purpose of describing particular embodiments only and is not intended to be limiting. As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected. If there is any conflict in the usages of a word or term in this specification and one or more patent or other documents that may be incorporated herein by reference, the definitions that are consistent with this specification should be adopted for the purposes of understanding this invention.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

What is claimed is:

1. A method comprising:
receiving multiple bets from a plurality of users with one or more servers via a network;
collectivizing a first group of the multiple bets to form a first group bet;
collectivizing a second group of the multiple bets to form a second group bet;
executing the first group bet and the second group bet in a virtual environment;
comparing the first group bet and the second group bet to one or more winning conditions and determining if the first group bet and/or the second group bet is a winning bet based on the one or more winning conditions; and
apportioning winnings to the plurality of users associated with the winning bet.

2. The method of claim 1, wherein the multiple bets comprise at least one bet-type selected from the group consisting of: a parlay bet, a straight line bet, a moneyline bet, a point spread bet, an over/under bet, a proposition bet, a teaser bet, and any combination thereof.

3. The method of claim 1, wherein the first group bet is a democratic reduction of multiple varied bets to a single bet.

4. The method of claim 3, wherein the second group bet is also a democratic reduction of multiple varied bets to a single bet.

5. A system comprising:
a server in communication with a plurality of devices in communication with the server via a network, wherein the server is configured to:
receive multiple bets from the plurality of devices;
collectivize a first group of the multiple bets to form a first group bet;
collectivize a second group of the multiple bets to form a second group bet;
execute the first group bet and the second group bet;
compare the first group bet and the second group bet to one or more winning conditions and determining if the first group bet and/or the second group bet is a winning bet based on the one or more winning conditions; and
apportion winnings to a plurality of users associated with the winning bet.
